(19) United States
(12) Patent Application Publication
(10) Pub. No.: US 2006/0067286 A1
(43) Pub. Date: Mar. 30, 2006

(54) Wireless asset monitoring system and method having designations of logical place

(75) Inventor: Kenneth D. Cornett, Coral Springs, FL (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(73) Assignee: Motorola, Inc.

(21) Appl. No.: 10/954,729

(22) Filed: Sep. 30, 2004

(51) Int. Cl. H04Q 7/24

(52) U.S. Cl. 370/338

(57) ABSTRACT

A system for wirelessly monitoring assets using a multi-hop communications network (10) includes a group of networked communications nodes for transmitting a beaconing radio frequency (RF) signal from a group of network nodes (11, 13, 15). One or more asset nodes (17, 19) are used for receiving the beaconing RF signal where the asset nodes (17, 19) determine if the asset is in an authorized location based upon logical place information received from the at least one network node. Logical place information includes an informal location name without the use of positional location coordinates. The invention is advantageous since it enables the asset to determine whether it is in an allowed, forbidden or disallowed location without the burden of calculating its physical position.

### CROSS REFERENCE TO RELATED APPLICATIONS

This application is related to pending U.S. application Ser. No. 10/787,987 entitled “Method and Apparatus for Transmitting Location Data Within an Ad-Hoc Communication System” filed on Feb. 26, 2004, and assigned to Motorola, Inc.

### TECHNICAL FIELD

This invention relates in general to asset location and more particularly to managing the proper location of assets based upon receipt of logical place information.

### BACKGROUND

Pervasive self organizing radio frequency (RF) networks such as ZigBee are known in the art and offer great advantage for providing communications between remote location monitoring devices. These networks work to locate and track associated communications devices operating in the network. Most often, these devices are attached to tangible assets that can be tracked around factories, assembly plants and/or other large building space. Certainly, asset location and tracking systems have great utility when used both for commercial and industrial applications.

An asset tracking network typically operates using a known position of a several nodes which are then used to determine the position of other nodes by triangulation or maximum-likelihood calculations of a matrix of peer-to-peer range estimates. These calculations are often performed at a centralized server or embedded processor at a network gateway. This requires a server or gateway to actively monitor many nodes, which is a computation burden that is well-known to grow rapidly with the number of objects monitored. In sign-post variations, each node receives location coordinate information from one or more known locations and may calculate its own position estimate. This approach can overcome the scaling problem of centralized position computation. Once the location of a single node is received, other nodes in the network can then use that position information in addition to one or more other RF signal parameters received at that location. These signal parameters are then used to calculate and identify the node's location in relation to a site map. The position on the site map identifies a node's likely physical location, e.g., as being in a particular room or portion thereof. This location can then be used along with additional information to determine the appropriateness of a node being within a particular region or defined space.

One problem associated with this type asset location system is that memory and computation resources must be dedicated to provide this location information. More specifically, since a node must calculate its own position, this often requires a high degree of computing power, memory and power consumption associated with the node to perform these tasks. In particular it requires that the node be able to store relevant map information and a means to provision it is necessary; either in a commissioning or configuration step prior to the node joining a network or dynamically over the network itself. Hence, in order to maintain a small physical size of the radio transceiver at the node, it often is difficult to store the necessary information and perform all location calculations while still allowing the transceiver to remain small, low cost and operate on minimal battery power.

Consequently, the need exists for a method by which a remote node in a self organizing RF asset tracking network can easily determine if it is in an allowed location without the burden of calculating its precise physical location or making comparison to maps, although nothing in this invention should be construed as prohibiting a node from additionally performing a position calculation. This would enable small, low current drain nodes to be produced which will be cost effective for use in asset allocation networks.

### SUMMARY OF THE INVENTION

Briefly, according to the invention, there is provided a method for monitoring assets using wireless transceivers for determining designations of logical place. A logical place as provided that uses an embedded program running on asset tagging nodes with very limited microprocessor memory and/or computation resources that makes decisions and takes action according to simple rules which are easy to implement. The method of the invention allows asset location to be implemented with minimal system resources since an asset may determine if it is in an allowed or forbidden location without actually determining its physical location through the determination and manipulation of position coordinates.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a diagram illustrating an asset management communications system having designations of logical place in accordance with the invention.

FIG. 2 is a diagram illustrating a top view of a hypothetical factory environment utilizing the method of wireless asset monitoring having designations of logical place in accordance with the invention.

FIG. 3 is a flow chart diagram illustrating step of the method for wireless asset monitoring in accordance with the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

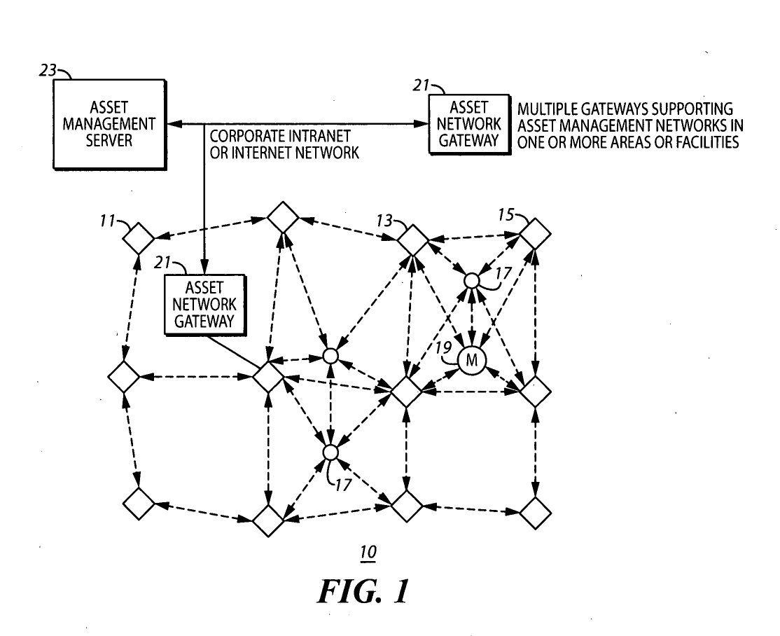

Referring now to FIG. 1, a diagram illustrating a asset management communications system having designations of logical place 10 in accordance with the invention includes a plurality of fixed communications nodes 11, 13 and 15 that form a matrix by communicating with other nodes in the system. The nodes 11, 13 and 15 are differing mode types having different capabilities with regard to position location, transmitter power and transmitted information. Nodes 11, 13 and 15 operate by periodically transmitting i.e. beaconing information with regard to their logical position. As discussed herein, the logical position of the node is information relating to its physical place at a designated location and not its location using positional coordinates. The dotted lines interconnection nodes 11, 13 and 15 and other nodes represent wireless network connectivity between these devices. One or more asset nodes 17 and mobile asset node 19 are used in the network to listen for logical place information transmitted by the fixed communications nodes 11, 13 and 15 to determine if they are in an allowed or forbidden location. An asset network gate communicates either through a wired or wireless link to convey network location information to an asset management server 23. Information conveyed to the asset management server can be communicated through a fixed intranet network or via the internet.

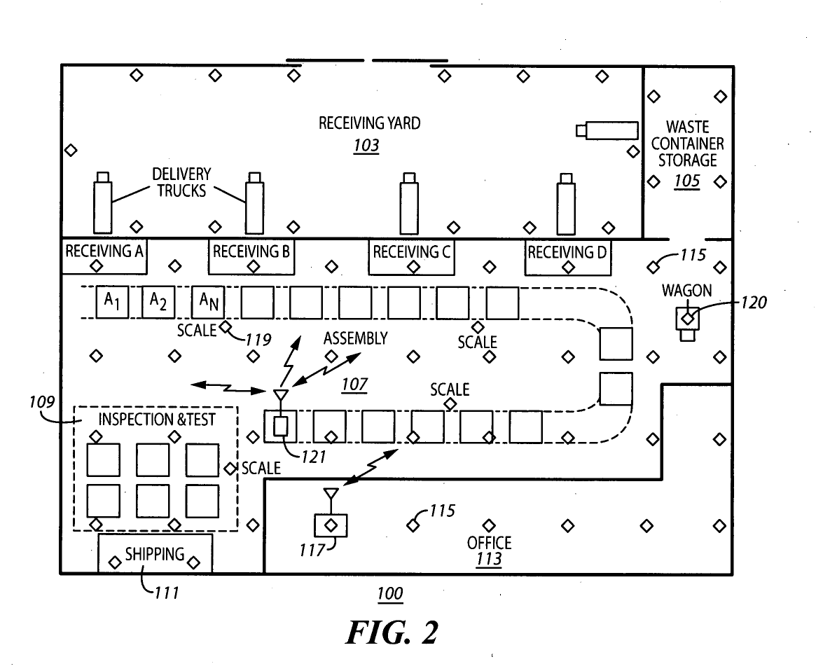

In FIG. 2, represents an example of the asset management system 10 where a typical assembly plant 100 utilizes the wireless asset monitoring system and method of the present invention. As noted in FIG. 1, a mesh/multi-hop network of short range transceivers or network nodes are used as a location infrastructure. In this example the plant 100 includes a receiving yard 103, waster container storage area 105, assembly line area 107, inspection and test area 109, shipping area 111 and office 113. A matrix of network nodes 115 are spaced throughout the plant 100 in order to provide uniform communications coverage throughout the physical space. Each of the network nodes 115 are managed through a central network station 117 that may be located in the office 113 or anywhere throughout the plant 100 or at a remote site via a private or public network such as an intranet or the internet. The system further includes a plurality of scale nodes 119 that work to measure the weight of fluids or other matter when located with the scale. This enables the scale node 119 to communicate with the central station 117 through the network nodes 115 in the event that a predetermined condition is met. For example, when the weight of a container reaches some maximum or minimum threshold level, it would signal to a network node 115 it approximate location in order to be serviced. Similarly, a wagon node 120 can act as a roving communications node that travels to these various locations within the plant 100 to pick-up, drop-off and or maintain the scale node 119 or other assets that are tracked throughout the network. Thus, each of the nodes is given a logical designation based on the functional area or special device in/on which it is installed. These might include office, assembly area, waste container storage, scale or wagon etc. This information is ideally included as a payload in a beacon or beacon-response packet.

In operation, each of the network nodes 115, including the scale nodes 119 and wagon node 120, include a set of application software variables that are located in an embedded memory of asset nodes which represent both a logical places and a state. These logical places are stored at the node in addition to a position in the local/global coordinate system. The local coordinate system is essentially a map of the plant 100 that indicates the location of all of the network nodes 115 and other nodes in relation to one another. The logical place names might include hypothetical locations for such items as an industrial waste bins or the various physical locations within the plant such as receiving yard 103, waste container storage 105, assembly line area 107, shipping area 111 or office 113. In an alternative embodiment, the place names may be stacked in a hierarchy providing increasing granularity from the designation of the plant to a building location to a room. Finally, the state conditions of each network node 115 or scale node 119 include 1) normal (allowed) state, 2) forbidden (disallowed) state or 3) lost state.

Using the example in plant 100, assets that are delivered at the receiving yard 103 are moved through receiving docks A-D. Assets A₁ to Aₙ may be tagged with an asset node 121 either before delivery or once at plant 100. An asset node 121 operates as a portable communications transceiver that is attached to and operates with the particular asset. An asset node may be provisioned with a list of designated places where they are allowed or forbidden to be located. Once activated, asset node 121 may communicate using any type of low current beaconing protocol with any network node 115 that may be in range. The asset node 121 will interpret received information from the network nodes 115 which also “beacons” logical place information at periodic intervals to assets that are within range of the node.

The asset node 121 will use its own list of logical places to compare and identify allowed place names for the asset to the information received from the network nodes 115, scale node 119 or wagon node 120. The asset node 121 will then determine its own state condition based on this information. If the asset node 121 determines that it is either in an allowed place (normal), forbidden place (disallowed) or if the location of the asset node 121 is lost since it has received neither an allowed or forbidden signal, these indications may be transmitted back to the central station 117 for recordation and further processing. In order to prioritize signals received from various communicators nodes, the received signal strength indication (RSSI) can be used to identify an allowed node likely to be the nearest to the asset node 121.

If no communications node transmitting an allowed place is within range, but other beaconing assets with an allowed place are present, the asset transceiver can set its state as shadowed but still assume that it is in an allowed place. This state may also be used in certain location methods to adjust assumptions about RF propagation parameters and/or estimating the uncertainty of the asset transceiver's calculated position in a coordinate system. If neither a communications node 119 nor an asset node 121 with an allowed place name is within range, an asset transceiver will associate with the closest communications node 121 available but will take additional actions which could include transmitting error messages containing available place or location indications available.

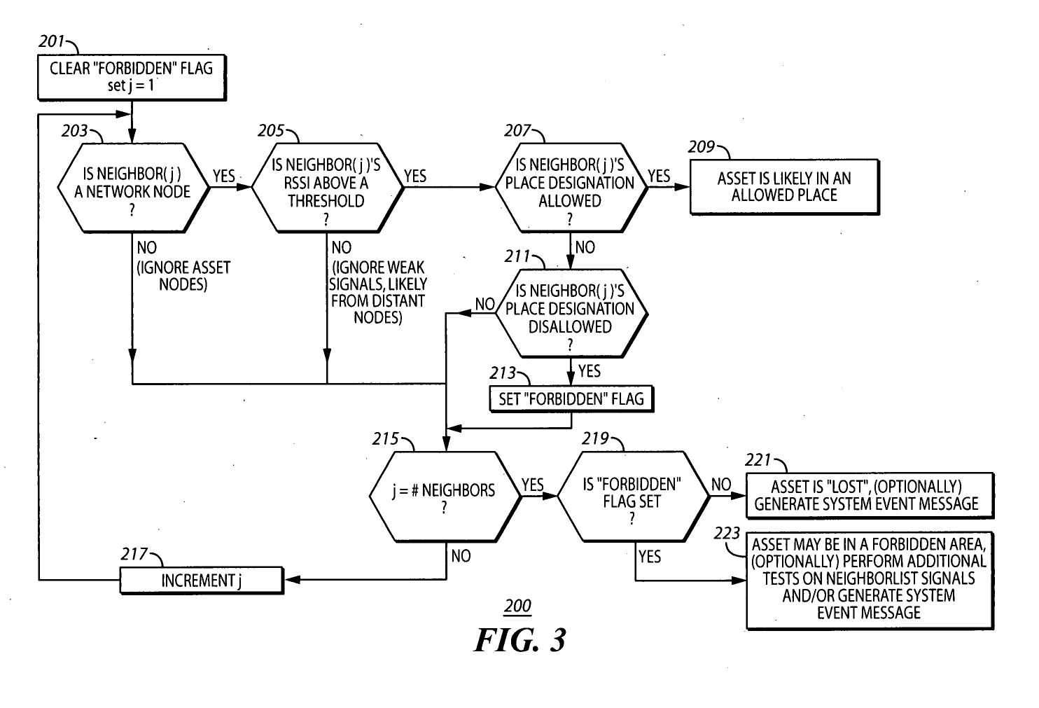

FIG. 3 is a flow chart diagram illustrating steps of the method for wireless asset monitoring having designations of logical place 200 in accordance with the invention. Initially, an asset node clears 201 its forbidden flag and sets an internal counter (j) to 1 for initializing itself within the network. When the asset node receives a communication from a network node 203 it further determines if the signal from the network node is about a predetermined RSSI threshold 205. If it is above this RSSI threshold and the neighboring node place designation is “allowed” 207, then the asset is also likely to be in an allowed place 209. Not comparing the RSSI to a threshold is to effectively setting the threshold value at zero and treat any received signal as being equally significant.

If the neighboring node is not a network node or the neighboring node's RSSI is not above the threshold level then a determination is made whether the value in the counter is equal to the total number of surrounding nodes from which the asset node is receiving signals 215. If this number is not equal the number of other signals from surrounding nodes being received then the counter is incremented 217 and the process begins anew. If it is determined that the place designation is something other than “allowed”, then it is determined if the place designation is disallowed 211. If it is disallowed than a forbidden flag is set in the asset node. If it is set forbidden or if it not disallowed in either case, the counter 215 is reviewed to determine if all signals have been received from surrounding network nodes.

If the counter has reached the number of received signals from all other network nodes in the vicinity, then a determination is made if the forbidden flag has been set by the asset node 219. If the forbidden flag had not been set then the asset node is lost 221 and may optionally generate a system event message to be ultimately received by a central station. If the forbidden flag is set then the asset may be in a forbidden area 223 and the asset node may perform additional tests on other signals received from network nodes and/or generate a system event message.

Thus, each asset node is provisioned with an allowed/disallowed place profile appropriate to its type. During normal operation, the asset node will build a list of nearby nodes with which it can exchange logical place information. This list of nearby nodes might be referred to as a neighbor list which is analyzed by the embedded application in the asset node to understand where it is located purely from a contextual point of view. This location is independent of any xyz location coordinate system that may be additionally employed. The network node works to compare received logical place information with its allowed/disallowed place profile to determine if it is in an allowed, disallowed or indeterminate location. If this location is forbidden, then the asset node will transmit this information to one or more network nodes where it can be conveyed to a central station.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A system for wirelessly monitoring assets using a multi-hop communications network comprising:
a plurality of networked communications nodes for transmitting a beaconing radio frequency (RF) signal from at least one network node;
at least one asset node for receiving the beaconing RF signal; and
wherein the at least one asset node determines if it is in an authorized location based upon logical place information received from the at least one network node.

2. A system for wirelessly monitoring assets as in claim 1, wherein the logical place information includes the name of a physical location in the communications network.

3. A system for wirelessly monitoring assets as in claim 1, wherein the logical place information includes state information including but not limited to the group of allowed place, forbidden place or lost place.

4. A system for wirelessly monitoring assets as in claim 1, further comprising:
at least one mobile asset node that moves about the networked communications nodes.

5. A system for wirelessly monitoring assets as in claim 4, wherein the at least one mobile asset node includes a detector for reporting changes in assets collocated with the asset node.

6. A method for wirelessly monitoring assets including the steps of:
forming a network using a plurality of network nodes and at least one asset node;
receiving logical place information at the at least one asset node from at least one of the plurality of network nodes; and
determining a status condition from the logical place information and transmitting the status condition regarding the at least one asset's location to at least one of the plurality of network nodes if the at least one asset is in an allowed, forbidden or lost location.

7. A method for wirelessly monitoring assets as in claim 6, wherein a lost location occurs when the at least one asset node receives neither a signal indicating an allowed location or forbidden location.

8. A method for wirelessly monitoring assets as in claim 6, wherein the logical place information includes the name of a physical location in the network.

9. A method for wirelessly monitoring assets as in claim 6, wherein the logical place information also includes state information including but not limited to the group of an allowed place or forbidden place.

10. A method for wirelessly monitoring assets as in claim 6, wherein the logical place information includes no positional coordinate information.

11. A method for wirelessly monitoring assets as in claim 6, wherein the at least one asset node is a portable node that moves about the plurality of network nodes.

12. A method for wirelessly monitoring assets as in claim 11, wherein the portable node includes a sensor for reporting changes in asset condition.

13. A method for monitoring assets using a multi-hop wireless communications network having a plurality of network nodes comprising the steps of:
initializing at least one asset node;
receiving a beaconing signal from at least one network node;
determining if the received signal strength indication (RSSI) from the at least one network node is above a predetermined threshold level;
determining a logical place information from the at least one network node; and
transmitting status information to the at least one network node if the at least one asst node is in a forbidden place.

14. A method for monitoring assets as in claim 13, wherein the logical place information include a physical location of the at least one network node without using physical coordinate information.

15. A method for monitoring assets as in claim 13, wherein the logical place information includes state information including but not limited to an allowed place, a forbidden place or a lost place.

16. A method for monitoring assets as in claim 13, wherein the at least one asset node is a mobile node that moves about the wireless communications network.

17. A method for monitoring assets as in claim 16, wherein the mobile node includes a detector for sensing changes in the at least one asset node for reporting to one of the plurality of network nodes.
